(19) United States
(12) Patent Application Publication
(10) Pub. No.: US 2012/0312057 A1
(43) Pub. Date: Dec. 13, 2012

(54) LOCKING DEVICE, PARTICULARLY FOR CONTAINERS OF THE TYPE OF SUITCASES, TRUNKS AND THE LIKE

(75) Inventor: Massimo TONELLI, CASALECCHIO DI RENO (IT)

(73) Assignee: G.T. LINE - S.R.L., CRESPELLANO (IT)

(21) Appl. No.: 13/443,562

(22) Filed: Apr. 10, 2012

(30) Foreign Application Priority Data
Apr. 11, 2011 (IT) BO2011A000190

(51) Int. Cl. E05B 67/02; E05B 67/08

(52) U.S. Cl. 70/20

(57) ABSTRACT

A locking device, particularly for containers of the type of suitcases, trunks and the like that have a pair of mutually articulated half-shells, comprising at least one padlock provided with a main body and a fastening bar, which can be inserted in mutually facing slots provided in respective raised edges arranged correspondingly on each one of the half-shells to determine stable locking of the container in the closure configuration.

The main body of the padlock has a recess, which is delimited at least partially by a back wall constituted by a part of the body. The recess is adapted to accommodate respective portions of the edges, which comprise the slots, and at least the part of the bar that is inserted therein, in order to substantially cover the coupling region between the bar and the edges, by means of the back wall, and to prevent access thereto by third parties.

The present invention relates to a locking device, particularly for containers of the type of suitcases, trunks and the like.

### BACKGROUND OF THE INVENTION

Currently there are many constructive solutions that resort to a padlock made of metal or other materials in order to mutually lock in the closure configuration the two mutually articulated half-shells of a suitcase, trunk or the like.

Typically, as is known, these padlocks are constituted by a main body, which contains the fastening mechanism of a bar (which is straight or U-shaped) which, after being inserted in adapted receptacles of the corresponding half-shells, can thus be locked stably in the acquired position so as to prevent, by interference, the opening of the container.

Adapted slots are thus often provided along the surfaces of the half-shells or on adapted protruding ribs provided along them and face each other and are mutually aligned when the container is in the closure configuration, and are thus capable of receiving the bar of the padlock and of consequently avoiding the danger of break-ins and unwanted accesses to the contents of the trunk or suitcase.

However, these constructive solutions are not free from drawbacks.

It should in fact be noted primarily that once the locking configuration has been provided some parts of the bar in any case remain substantially exposed and/or in any case easily accessible from outside, for example through the gap comprised between the two mated faces of the above cited edges, in which the holes or slots are provided. This accordingly offers an ill-intentioned individual who has a sufficiently sharp blade or other adapted break-in tools the possibility to force the lock by breaking the bar.

Moreover, in the locking configuration that occurs when the bar is inserted in the holes, the play that is normally provided between these elements allows the main body of the padlock to perform small oscillations and movements which are often unwelcome, since they are noisy and potentially capable of scuffing and scratching the half-shells of the suitcase, as well as other objects (and also people) who might come into contact with the suitcase.

These unpleasant consequences are worsened by the fact that also due to the oscillations the padlock often protrudes significantly from the profile of the half-shells, thus increasing the risk of unwanted impacts.

Finally, it should be noted that the padlock often has shapes and lines that are completely dissonant with respect to those of the container for which it is intended to be used, in practice compromising the pleasantness of the overall appearance of the container, and this is unacceptable for the consumer, who pays more and more attention to the design of the products that he/she uses.

### SUMMARY OF THE INVENTION

The aim of the present invention is to solve the above mentioned problems, by providing a locking device that is capable of ensuring high security against break-in attempts.

Within the scope of this aim, an object of the invention is to provide a locking device that can be associated stably with a container, of the type of a suitcase, trunk or the like, without the possibility of accidental movements or oscillations.

Another object of the invention is to provide a locking device that has a pleasant appearance, according to shapes that harmonize with those of the container for which it is intended to be used.

Another object of the invention is to provide a locking device that can have a modest space occupation once it has been coupled to the container to be locked in the closure configuration.

A further object of the invention is to provide a locking device that ensures high reliability in operation.

Another object of the invention is to provide a locking device that can be obtained easily starting from commonly commercially available elements and materials.

Another object of the invention is to provide a locking device that has modest costs and is safe in application.

Another object of the invention is to provide a fastening assembly in which the container can be locked with high security against break-in attempts.

This aim, as well as these and other objects that will become better apparent hereinafter, are achieved by a locking device, particularly for containers of the type of suitcases, trunks and the like, that have a pair of mutually articulated half-shells, comprising at least one padlock provided with a main body and a fastening bar, which can be inserted in mutually facing slots provided in respective raised edges arranged correspondingly on each one of the half-shells for stable locking of the container in the closure configuration, characterized in that said main body of said padlock has a recess, which is delimited at least partially by a back wall constituted by a part of said body, said recess being adapted to accommodate respective portions of said edges, which comprise said slots, and at least the part of said bar that is inserted therein, in order to substantially cover the coupling region between said bar and said edges, by means of said back wall, and to prevent access thereto by third parties.

### BRIEF DESCRIPTION OF THE DRAWINGS

Further characteristics and advantages of the invention will become better apparent from the description of two preferred but not exclusive embodiments of the locking device according to the invention, illustrated by way of non-limiting example in the accompanying drawings, wherein:

FIGS. 1 to 4 are views of the locking device according to the invention in the first embodiment, and more precisely:

FIG. 1 is a side front perspective view of the locking device according to the invention in a first position for use of the fastening bar;

FIG. 2 is a side front perspective view of the locking device according to the invention in a second position for use of the fastening bar;

FIG. 3 is a side rear perspective view of the device according to the invention;

FIG. 4 is a highly enlarged-scale view of a detail of FIG. 2;

FIG. 5 is a view of the use of the locking device for locking a container;

FIGS. 6 to 8 are views of the locking device according to the invention in the second embodiment, and more precisely:

FIG. 6 is a view of the use of the locking device for locking a container;

FIG. 7 is a highly enlarged-scale view of the detail of FIG. 6;

FIG. 8 is a view of a method of application of the locking device according to the invention for locking the container of FIG. 6.

### DESCRIPTION OF THE PREFERRED EMBODIMENTS

With reference to the cited figures, a locking device according to the invention, generally designated by the reference numeral 1, is particularly suitable for application on containers 2 of the type of suitcases, trunks and the like, which have a pair of mutually articulated half-shells 3 according to a plurality of possible embodiments as a function of the specific requirements of application and of the particular design choices.

It is specified immediately that the use of the device 1 for locking containers 2 of the type of suitcases or trunks of any shape and size is a preferred application of the present invention and shall be referenced specifically in the continuation of the present description, but the possibility is not excluded, and is in any case within the protective scope claimed herein, to use the device 1 to fasten different objects and products.

The locking device 1 comprises at least one padlock 4 which has a main body 5 and a fastening bar 6, which can be inserted in slots 7 provided in respective raised edges 8, which are arranged correspondingly on each one of the half-shells 3. When the container 2 is closed and the perimetric edges of the half-shells 3 are in mutual contact, the slots 7 face each other in order to allow the insertion of the bar 6 in both and the stable locking, by means of the padlock 4, of the container 2 in the closure configuration (which is preferably provided by means of a fastening element even of a known type).

According to the invention, the main body 5 of the padlock 4 has a recess 9, which is delimited at least partially by a bottom wall 5a which is constituted by a part of the body 5 and is capable of accommodating respective portions of the edges 8 and in greater detail the portions that comprise the slots 7, and at least the part of the bar 6 that is inserted therein. This allows substantially to cover the coupling region between the bar 6 and the edges 8 by means of the bottom wall 5a, at the same time preventing access thereto by third parties and thus avoiding the danger that an ill-intentioned individual might force them or break them in order to open the container 2, in practice achieving the intended aim. Differently from what occurs in padlocks of the known type, the elements involved in the coupling and fastening of the container 2 in fact are not accessible from outside: the bar 6, and especially the portions of the edges 8, which are typically made of scarcely resistant materials (polymeric materials, for example), are protected by the padlock 4 itself, which prevents third parties from making contact with them (and possibly damaging or forcing them).

According to a constructive solution of substantial practical interest, which is mentioned by way of non-limiting example of the application of the invention, the recess 9 has a shape and dimensions which are complementary to those of the portions of the edges 8, including the slots 7. This constructive choice makes it possible to usefully perform a shape mating and consequently a stable fixing of the padlock 4 to the half-shells 3 upon the locking of the container 2, thus preventing any oscillations and unwanted movements of the padlock 4.

Moreover, the body 5 can have (preferably but not exclusively) a substantially polyhedral shape (for example the shape of a parallelepiped or even having one or more inclined planes, but the use of curved surfaces is not excluded), preferably chosen in harmony with the lines and the profile of the container 2 and of its edges 8, in order to blend in with the design and the outer surfaces of the container 2 and of the edges 8, in order to ensure an absolutely attractive appearance.

More particularly, according to the constructive solution illustrated by way of non-limiting example in the accompanying figures, the above cited portions of the edges 8 have respective protrusions 8a that protrude externally and comprise the slots 7. In the closure configuration the protrusions 8a are in contact and face each other and have, when mated, a shape which is substantially complementary to that of the recess 9, which has a substantially polyhedral shape.

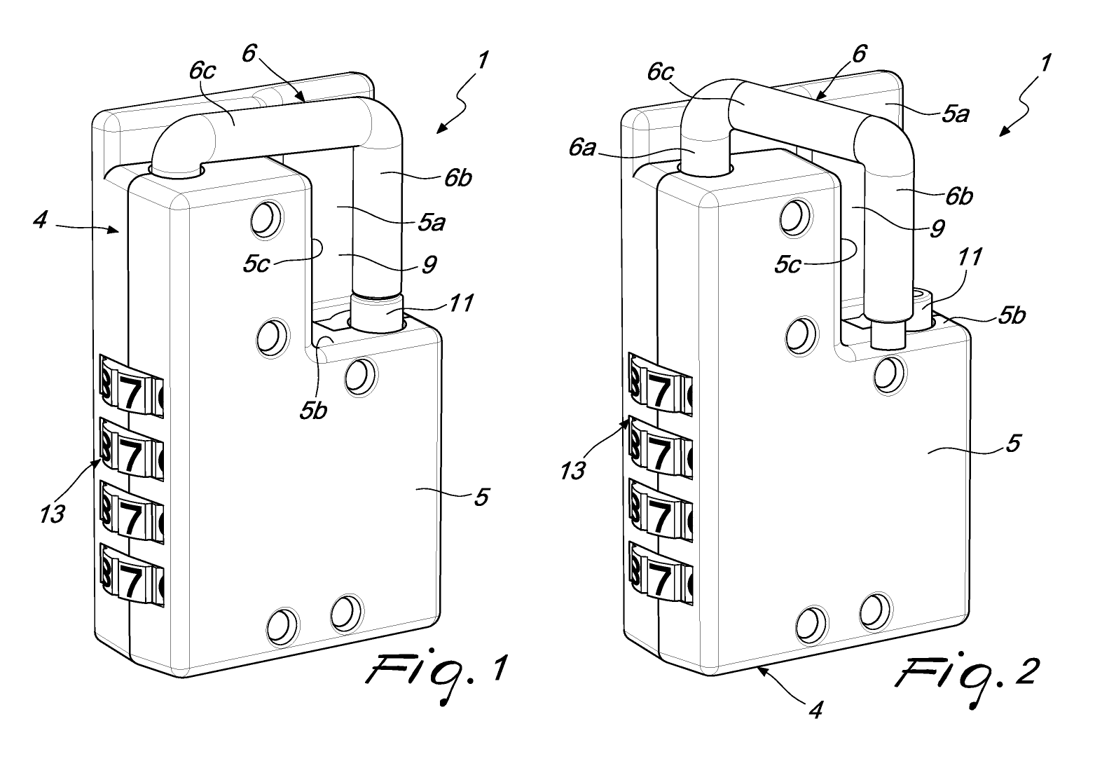

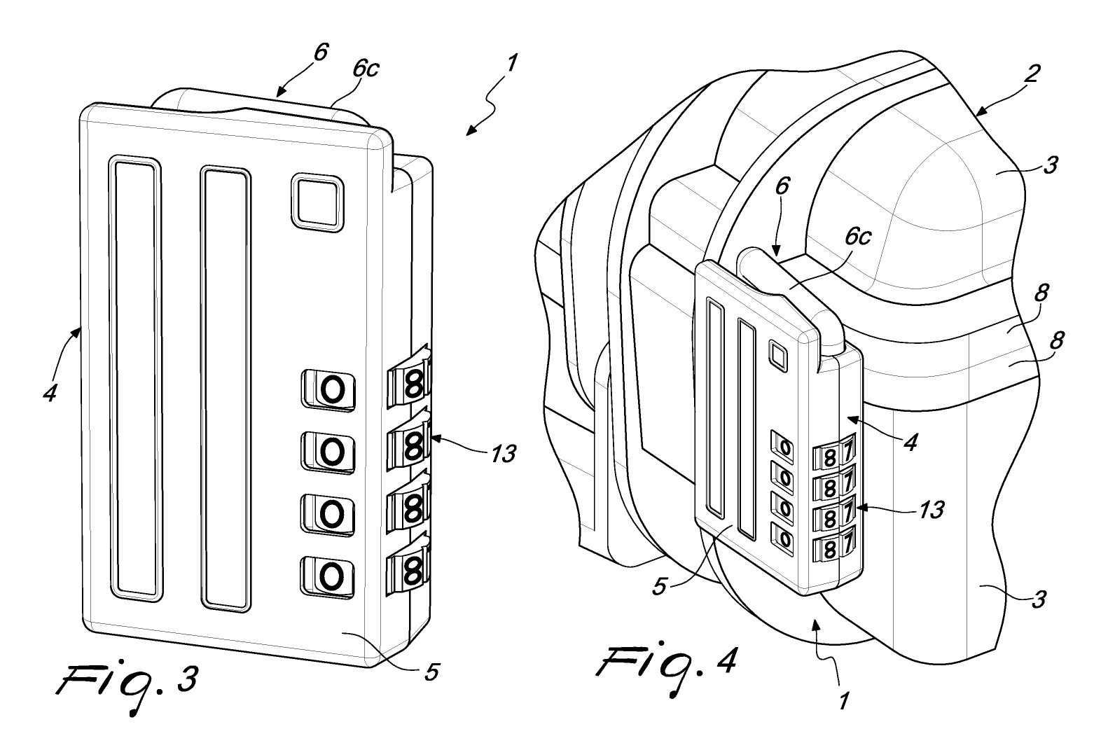

Conveniently, according to a first preferred embodiment, proposed in FIGS. 1 to 4 by way of non-limiting example of the application of the invention, the recess 9 having a substantially polyhedral shape is delimited at least by the back wall 5a, by a first face 5b of the body 5 and by a second face 5c of the body 5. The first face 5b and the second face 5b are consecutive, substantially flat and mutually perpendicular. In this manner, the back wall 5a, the first face 5b and the second face 5c constitute an abutment for the protrusions 8a, so as to allow the mutual coupling and the stable fixing of the padlock 4 to the half-shells 3 upon the locking of the container 2, in order to prevent unwanted oscillations and movements.

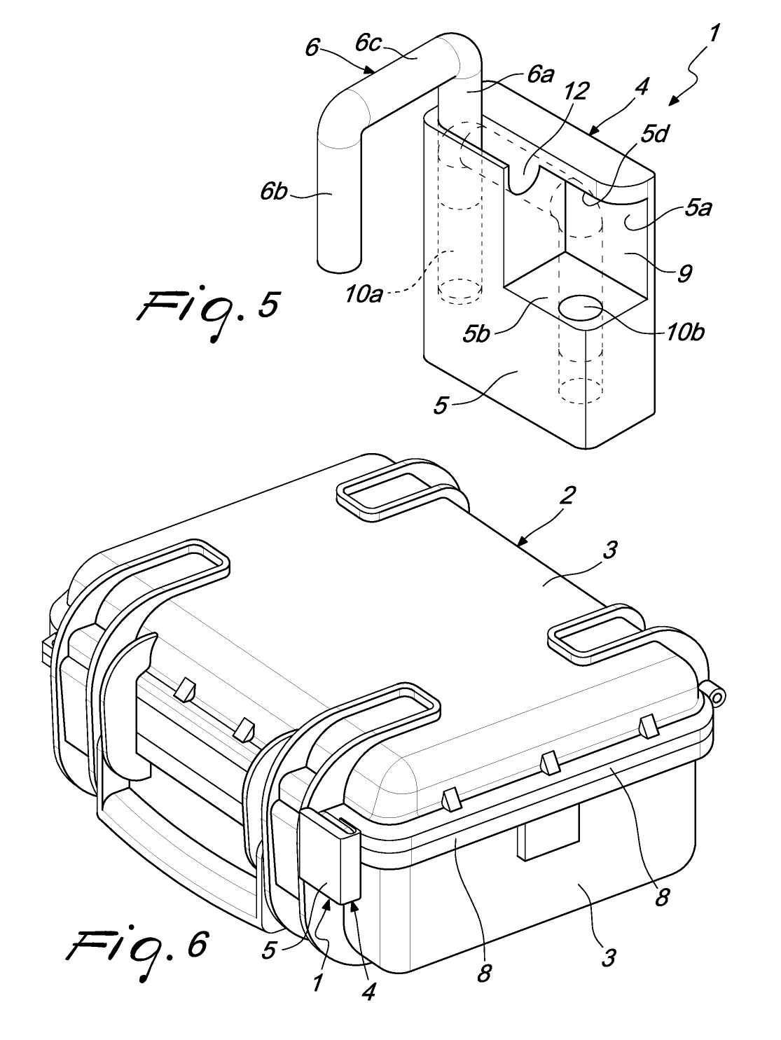

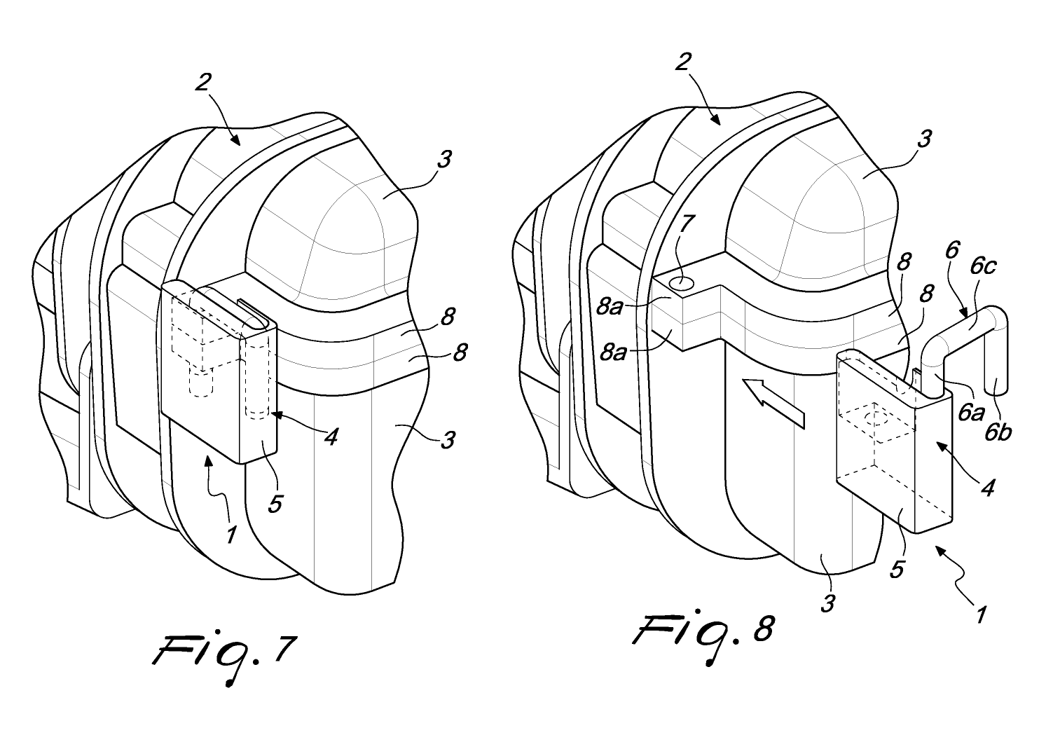

According to a different embodiment (which is shown in FIGS. 5 to 8 and in any case does not exhaust the possible embodiments that fall within the protective scope claimed herein), the recess 9, having a substantially polyhedral shape, is delimited by the back wall 5a, by the first face 5b of the body 5 and by a third face 5d of the body 5. The first face 5b and the third face 5d are mutually opposite, are substantially flat and have a center distance that is equal to the overall thickness of the protrusions 8a, for shape mating with them and for stable fixing of the padlock 4 to the half-shells 3 upon the locking of the container 2, thus preventing, as noted, any unwanted oscillations and movements.

The choice of the shape of the recess 9 (in addition to allowing shape mating with the edges 8) can also be such as to continue the lines and patterns of the shape of the body 5 and of the container 2, in order to give the container 2 and the padlock 4 a highly pleasant design.

Conveniently, and with additional reference to the embodiment proposed in the accompanying figures by way of non-limiting example, the fastening bar 6 has at U-like curved shape, thus defining a first end arm 6a and a second end arm 6b, which are mutually parallel and are connected by a transverse central portion 6c.

In turn, the body 5 has a first channel 10a and a second channel 10b, which leads to the first face 5b. The first end arm 6a of the fastening bar 6 can slide rotatably within the first channel 10a in order to allow the movement of the bar 6 with respect to the body 5 and its insertion in the slots 7. The rotation of the bar 6 about the axis defined by the first channel 10a and the sliding along it (and therefore the movement of the bar 6) thus makes it possible to provide mating between the bar 6 and the two mutually facing slots 7 of the edges 8, as well as their subsequent disengagement (if one wishes to access the contents of the container 2).

The second end arm 6b of the bar 6 is at least partially associable indeed with the second channel 10b (for example by inserting the second end arm 6b in the bar 6, as in the embodiment shown in FIGS. 5 to 8), for stable locking in the closure configuration of the container 2.

In the solution shown in FIGS. 1 to 4 there is a bush 11, which in turn is inserted in the second channel 10b and is capable of receiving the second end arm 6b of the bar 6.

In order to contain the overall dimensions, when the padlock 4 is arranged in the configuration for locking the container 2, which in turn is arranged in the closure configuration, in the embodiment of FIGS. 5 to 8 the body 5 has a groove 12 which is adapted to accommodate the central portion 6c of the fastening bar 6, when the second end arm 6b is at least partially inserted in the second channel 10b (a condition which indeed corresponds to the locking of the container 2 by means of the insertion of the bar 6 in the slots 7).

Conveniently, the body 5 has means for anchoring the bar 6 (even of a known type) and the second end arm 6b can engage automatically such anchoring means (which optionally can be deactivated selectively with a combination mechanism 13, as in the embodiment visible in FIGS. 1 to 4), upon its meeting with the second channel 10b.

For example, according to known methods, the insertion of the second end arm 6b in the second channel 10b causes (automatically or by means of a key) the mating between a hollow provided in the second end arm 6b and a grub which protrudes on the second channel 10b, which by interference prevents any subsequent sliding of the bar 6 with respect to the body 5, allowing the padlock 4 to lock the container 2.

Even more precisely, the locking device 1 comprises an elastic element (for example a spring conveniently placed within the main body 5), which abuts against the bar 6: the elastic reaction of the element causes the sliding of the bar 6 for its expulsion and the uncoupling from the first channel 10a and from the second channel 10b in order to allow its movement upon the disengagement of the bar 6 from the anchoring means.

The elastic element allows easier extraction of the bar 6 from the closure position, in which otherwise, indeed due to the choice to contain the overall space occupation, it might be more awkward for the user to move the bar 6 and release the half-shells 3 if he/she wishes to open the container 2.

The elastic reaction of the elastic element can be such as to expel automatically (at least partially) the bar 6 if, for example by means of the above mentioned key, the action of the protruding grub is deactivated or the elastic element can act as a consequence of a pressure on the bar 6 which makes it possible to disengage the hollow from the grub.

Operation of the locking device according to the invention is as follows.

As already noted, if one wishes to lock stably the two half-shells 3 of the container 2 in the closure configuration and prevent the opening of the container 2, it is possible to insert the bar 6 and in particular the second end arm 6b in the slots 7 and then insert the arm 6 in the second channel 10b and, by means of the anchoring means, fix the bar 6 to the body 5.

In this arrangement, as described in the previous paragraphs, the part of the bar 6 that is inserted in the slots 7, as well as the portions (or protrusions 8a) of the edges 8 that contain them, are substantially accommodated in the recess 9 of the body 5 and the back wall 5a covers them. This makes it impossible to access the coupling region (which is indeed interposed between the back wall 5a of the body 5 and the container 2 itself), except by acting on the lock (of the type with a key or combination mechanism 13 or others of a known type) of the padlock 4. The danger of break-in, achieved by acting on exposed areas of the bar 6, as instead occurs with padlocks and devices of the known type, is thus avoided.

If one wishes to open the container 2, it is sufficient to act on the anchoring means (by means of the above mentioned lock) in order to disengage the second end arm 6b, and therefore the bar 6, from the second channel 10b, to then extract the bar 6 from the slots 7.

Furthermore, as noted for the two embodiments proposed in the preceding paragraphs by way of non-limiting example of the application of the invention, the choice to provide the recess 9 according to shapes and dimensions which are complementary to those of the outer surfaces of the edges 8 makes it possible to provide a shape mating which is substantially stable when the portions of the edges 8 and the part of the bar 6 are accommodated in the recess 9. This avoids the danger of accidental movements or oscillations of the padlock 4 when it is fixed to the container 2, preventing scuffing and/or scratches of the container 2 or other objects.

Moreover, the choice to use a substantially polyhedral shape for the body 5 and optionally for the recess 9 (similar to that of the container 2 and of its edges 8) makes it possible to provide a locking device 1 that has a pleasant appearance, according to shapes which blend in indeed with those of the container 2 (and more precisely of the edges 8, whose outer surfaces are preferably flat or inclined) for which it is intended to be used.

It should also be noted that the presence of the groove 12 makes it possible to reduce the overall space occupation of the padlock 4 when it is engaged to lock the container 2, and this is a further assurance against the danger of scratches and scuffing, and furthermore contributes to give the device 1, coupled to the container 2, a pleasant and attractive design and to reduce the possibility of break-in, making the entire bar 6 substantially inaccessible.

It is furthermore useful to note that the padlock 4 can be provided according to TSA standards, with which, as is known, containers 2 such as suitcases or trunks (and especially their closure accessories, such as indeed the padlock 4) must comply, in order to facilitate access and inspection on the part of competent authorities in case of shipping toward or from the United States.

The fastening assembly according to the invention comprises a container 2 and a locking device 1 for the latter: the container 2 is of the type of suitcases, trunks and the like and has a pair of mutually articulated half-shells 3. The device 1 comprises at least one padlock 4 which is provided with a main body 5, and a locking bar 6, which can be inserted in mutually facing slots 7 provided in respective raised edges 8 which are provided correspondingly on each one of the half-shells 3, for stable locking in the closure configuration of the container 2.

According to the invention, the main body 5 of the padlock 4 has a recess 9, which is delimited at least partially by a back wall 5a constituted by a part of the body 5 and which is adapted to accommodate respective portions of the edges 8, which comprise the slots 7, and the bar segment 6 inserted therein, to substantially cover the coupling region between the bar 6 and the edges 8 by means of the back wall 5a. This prevents access of third parties to such region and allows the fastening assembly to ensure high security against break-in attempts when the container 2 is locked in the closure configuration.

In practice it has been found that the locking device according to the invention fully achieves the intended aim, since the use of a padlock in which the main body has a recess delimited by a back wall constituted by a part of the body itself, capable of accommodating respective portions of the edges defined on the half-shells of the container to be locked in the closure configuration, as well as the part of the bar of the padlock that is inserted in the edges, makes it possible to substantially cover the coupling region between the bar and the edges by means of the back wall, preventing access thereto by third parties and thus providing a locking device that can ensure a high level of security against break-in attempts.

The invention thus conceived is susceptible of numerous modifications and variations, all of which are within the scope of the appended claims. All the details may furthermore be replaced with other technically equivalent elements.

In the exemplary embodiments shown, individual characteristics, given in relation to specific examples, may actually be interchanged with other different characteristics that exist in other exemplary embodiments.

Moreover, it should be noted that anything found to be already known during the patenting process is understood not to be claimed and to be the subject of a disclaimer.

In practice, the materials used, as well as the dimensions, may be any according to requirements and to the state of the art.

The disclosures in Italian Patent Application no. BO2011A000190, from which this application claims priority, are incorporated herein by reference.

What is claimed is:

1. A locking device, particularly for containers of the type of suitcases, trunks and the like that have a pair of mutually articulated half-shells, comprising at least one padlock provided with a main body and a fastening bar, which can be inserted in mutually facing slots provided in respective raised edges arranged correspondingly on each one of the half-shells for stable locking of the container in the closure configuration, wherein said main body of said padlock has a recess, which is delimited at least partially by a back wall constituted by a part of said body, said recess being adapted to accommodate respective portions of said edges, which comprise said slots, and at least the part of said bar that is inserted therein, in order to substantially cover the coupling region between said bar and said edges, by means of said back wall, and to prevent access thereto by third parties.

2. The locking device according to claim 1, wherein said recess has a shape and dimensions which are complementary to those of said portions of said edges, for shape mating and consequent stable fixing of said padlock to the half-shells upon locking of the container, to prevent unwanted oscillations and movements.

3. The locking device according to claim 1, wherein said portions of said edges are provided with respective protrusions which protrude externally and comprise said slots, in said closure configuration said protrusions being in contact and facing each other and having, when mated, a configuration which is substantially complementary to the configuration of said recess, which has a substantially polyhedral shape.

4. The locking device according to claim 3, wherein said recess, having a substantially polyhedral shape, is delimited at least by said back wall, by a first face of said body and by a second face of said body, said first face and said second face being consecutive, substantially flat and mutually perpendicular, said back wall, said first face and said second face constituting an abutment for said protrusions, for the mutual coupling and stable fixing of said padlock to the half-shells upon locking of the container, in order to prevent unwanted oscillations and movements.

5. The locking device according to claim 3, wherein said recess, having a substantially polyhedral shape, is delimited at least by said back wall, by a first face of said body and by a third face of said body, said first face and said third face being mutually opposite, substantially flat and having a center distance equal to the total thickness of said protrusions, for shape mating with them and with said back wall and consequent stable fixing of said padlock to the half-shells upon locking of the container, in order to prevent unwanted oscillations and movements.

6. The locking device according to claim 4, wherein said fastening bar has a U-like curved shape, said body having a first channel and a second channel, which leads to said first face, a first end arm of said bar being able to slide rotatably in said first channel in order to allow the movement of said bar with respect to said body and its insertion in said slots, a second end arm of said bar being associable with said second channel, for the stable locking in the closure configuration of the container.

7. The locking device according to claim 6, wherein said body has a groove that is adapted to accommodate a central portion of said fastening bar when said second end arm is inserted at least partially in said second channel, in order to contain the overall space occupation upon locking of the container in the closure configuration.

8. The locking device according to claim 7, wherein said body has means for anchoring said bar, said second end arm being automatically engageable with said anchoring means, upon its coupling to said second channel.

9. The locking device according to claim 7, comprising an elastic element that abuts against said bar, the elastic reaction of said element causing the sliding of said bar for its expulsion and uncoupling from said first channel and from said second channel, to allow the movement of said bar upon disengagement thereof from said anchoring means.

10. A fastening assembly, comprising a container and a device for locking it, said container being of the type of a suitcase, trunk and the like, and having a pair of half-shells which are mutually articulated, said device comprising at least one padlock, which is provided with a main body, and a fastening bar, which can be inserted in mutually facing slots provided in respective raised edges arranged correspondingly on each one of the half-shells, for the stable locking in the closure configuration of said container, wherein said main body of said padlock has a recess, which is delimited at least partially by a back wall constituted by a part of said body, said recess being adapted to accommodate respective portions of said edges, which comprise said slots, and the part of said bar that is inserted therein, in order to substantially cover the coupling region between said bar and said edges, by means of said back wall, and to prevent access thereto by third parties.
